(19) United States
(12) Patent Application Publication
(10) Pub. No.: US 2018/0018772 A1
(43) Pub. Date: Jan. 18, 2018

(54) DYNAMIC ANALYSIS APPARATUS

(71) Applicant: Konica Minolta, Inc., Tokyo (JP)

(72) Inventors: Koichi FUJIWARA, Osaka (JP); Hitoshi FUTAMURA, Tokyo (JP); Akinori TSUNOMORI, Tokyo (JP); Sho NOJI, Tokyo (JP)

(21) Appl. No.: 15/623,857

(22) Filed: Jun. 15, 2017

(30) Foreign Application Priority Data
Jul. 13, 2016 (JP) 2016-138093

(51) Int. Cl. G06T 7/00; G06K 9/62; G06T 11/60

(52) U.S. Cl. CPC G06T 7/0016; G06T 11/60; G06K 9/6212; G06T 2207/10116; G06T 2207/30061; G06T 2207/10016

(57) ABSTRACT

A dynamic analysis apparatus includes: a signal change extracting unit configured to extract from dynamic images obtained by radiographing a subject including a target part in a living body, a signal change of a pixel signal value of each pixel in a region of the target part in a time direction; a reference value setting unit configured to set a reference value for each pixel on the basis of the signal change of each pixel; a generating unit configured to calculate an analysis value expressing a difference between the pixel signal value of each pixel in each frame image of the dynamic images and a reference value set for a time change of each pixel, thereby generating analysis result images including frame images; and a displaying unit configured to display the frame images of the analysis result images as a motion image or side by side.

The entire disclosure of Japanese Patent Application No. 2016-138093 filed on Jul. 13, 2016 including description, claims, drawings, and abstract are incorporated herein by reference in its entirety.

### BACKGROUND OF THE INVENTION

### Field of the Invention

The present invention relates to a dynamic analysis apparatus.

### Description of the Related Art

In recent years, with the digital techniques applied to the radiography, images capturing the motion of an affected part (referred to as dynamic images) can be obtained relatively easily. For example, by the photographing with the use of a semiconductor image sensor such as an FPD (Flat Panel Detector), the dynamic images capturing a structure including the part to be checked or diagnosed (referred to as a target part) can be obtained.

In a recently started attempt, the dynamic images are analyzed and the analysis result is used in the diagnosis.

For example, JP 4404291 B2 has disclosed the following:

(1) a plurality of difference images is generated by taking a difference between two timely adjacent frame images in dynamic images, and an image is generated from the generated plurality of difference images using any one of the maximum value, the minimum value, the average value, and the intermediate value of the pixel values as the pixel value of each pixel group for each of pixel groups corresponding to each other; and

(2) a reference image is generated from the dynamic images using any one of the maximum value, the minimum value, the average value, and the intermediate value of the pixel values of the pixel group as the reference pixel value for each corresponding pixel group, a plurality of difference images is generated by taking a difference between the reference image and the plurality of dynamic images, and an image is generated from the generated plurality of difference images using anyone of the maximum value, the minimum value, the average value, and the intermediate value of the pixel values of each pixel group as the pixel value corresponding to the pixel group for each of pixel groups corresponding to each other.

However, when the difference is taken between the adjacent frame images as described above in (1), the change value is small and the characteristic of the dynamic state is not remarkably observed, so that it is uneasy to use this in the diagnosis. In the techniques of (1) and (2), one image is generated as the final output image; therefore, it cannot be known which frame image expresses the pixel value of each pixel. As a result, it is impossible to compare the value of the final output image and each frame image of the original dynamic images.

### SUMMARY OF THE INVENTION

An object of the present invention is to make it easier to know the characteristic of the change in pixel signal value of the dynamic images photographing a target part in the time direction in accordance with each frame image of the dynamic images.

To achieve the abovementioned object, according to an aspect, a dynamic analysis apparatus reflecting one aspect of the present invention comprises:

a signal change extracting unit configured to extract from dynamic images obtained by radiographing a subject including a target part in a living body, a signal change of a pixel signal value of each pixel in at least a region of the target part in a time direction;

a reference value setting unit configured to set a reference value for each pixel on the basis of the signal change of each pixel;

a generating unit configured to calculate an analysis value expressing a difference between the pixel signal value of each pixel in each frame image of the dynamic images and a reference value set for a time change of each pixel, thereby generating analysis result images including a plurality of frame images; and

a displaying unit configured to display the plurality of frame images of the analysis result images as a motion image or side by side.

According to an invention of Item. 2, in the dynamic analysis apparatus of Item. 1,

the signal change extracting unit preferably sets a plurality of regions of interest to each of which each pixel in at least the region of the target part is related for each frame image of the dynamic images, calculates a representative value of pixel signal values in the set region of interest as the pixel signal value of the pixel related to the region of interest, and extracts the signal change of the pixel signal value of each pixel in the time direction.

According to an invention of Item. 3, in the dynamic analysis apparatus of Item. 2,

the representative value of the pixel signal values in the region of interest is preferably an average value, a central value, a maximum value, or a minimum value of the pixel signal values in the region of interest.

According to an invention of Item. 4, in the dynamic analysis apparatus of any one of Items. 1 to 3,

the signal change extracting unit preferably performs a frequency filter process on the extracted signal change of the pixel signal value of each pixel in the time direction.

According to an invention of Item. 5, in the dynamic analysis apparatus of any one of Items. 1 to 4,

the reference value setting unit preferably sets the reference value of each pixel to an average value, a central value, a maximum value, or a minimum value of the signal change of the pixel signal value of each pixel in the time direction.

According to an invention of Item. 6, in the dynamic analysis apparatus of any one of Items. 1 to 4,

the reference value setting unit preferably sets the pixel signal value of each pixel in a particular frame image of the dynamic images as the reference value of each pixel.

According to an invention of Item. 7, in the dynamic analysis apparatus of any one of Items. 1 to 6,

the generating unit preferably calculates a difference between the pixel signal value of each pixel and the reference value set to each pixel or a ratio thereof as an analysis value expressing a difference between the pixel signal value of each pixel in each frame image of the dynamic images and the reference value set to each pixel.

According to an invention of Item. 8, in the dynamic analysis apparatus of any one of Items. 1 to 7,

the displaying unit preferably displays the analysis result images having a color according to the analysis value in each pixel.

According to an invention of Item. 9, in the dynamic analysis apparatus of Item. 8,

the color according to the analysis value is preferably assigned so that a color difference between colors corresponding to a maximum value and a minimum value of the analysis value is the largest.

According to an invention of Item. 10, in the dynamic analysis apparatus of any one of Items. 1 to 9,

the displaying unit preferably displays a motion image of the dynamic images and a motion image of the analysis result images side by side.

According to an invention of Item. 11, in the dynamic analysis apparatus of any one of Items. 1 to 9,

the displaying unit preferably displays the frame images of the dynamic images and the corresponding frame images of the analysis result images side by side.

According to an invention of Item. 12, in the dynamic analysis apparatus of any one of Items. 1 to 9,

the displaying unit preferably displays the dynamic images and the analysis result images while overlaying each frame image of the analysis result images on the corresponding frame image of the dynamic images.

According to an invention of Item. 13, in the dynamic analysis apparatus of any one of Items. 1 to 12,

the displaying unit preferably displays a graph expressing a change of the analysis value at a predetermined point set on the analysis result image in a time direction together with the analysis result image.

According to an invention of Item. 14, in the dynamic analysis apparatus of any one of Items. 1 to 12,

the displaying unit preferably displays a representative value of analysis values in a predetermined region set on the analysis result image together with the analysis result image.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a diagram illustrating an entire structure of a dynamic analysis system according to an embodiment of the present invention;

FIG. 2 is a flowchart showing a photographing control process to be executed by a control unit of a photographing console of FIG. 1;

FIG. 3 is a flowchart showing an image analysis process to be executed by a control unit of a diagnosis console of FIG. 1;

FIGS. 4A and 4B show examples of setting regions of interest;

FIG. 5 shows the signal change of the pixel signal value extracted in step S12 in FIG. 3 in the time direction;

FIG. 6 shows results of performing a low-pass filter process on the waveform in FIG. 5;

FIG. 7 shows results of calculating the difference between a pixel signal value of each frame image and a reference value thereof;

FIG. 8 shows an example of display of the analysis result image;

FIG. 9 shows another example of display of the analysis result image;

FIG. 10 shows another example of display of the analysis result image;

FIG. 11 shows an example of display of a graph of signal change at a predetermined point on analysis result images;

FIG. 12 shows an example of display of analysis result images by the operation on the graph; and

FIG. 13 shows an example of display of a quantitative value of a predetermined region on the analysis result image.

### DESCRIPTION OF THE PREFERRED EMBODIMENTS

Hereinafter, an embodiment of the present invention will be described in detail with reference to the drawings. However, the scope of the invention is not limited to the illustrated examples.

[Structure of Dynamic Analysis System 100]

First, a structure is described.

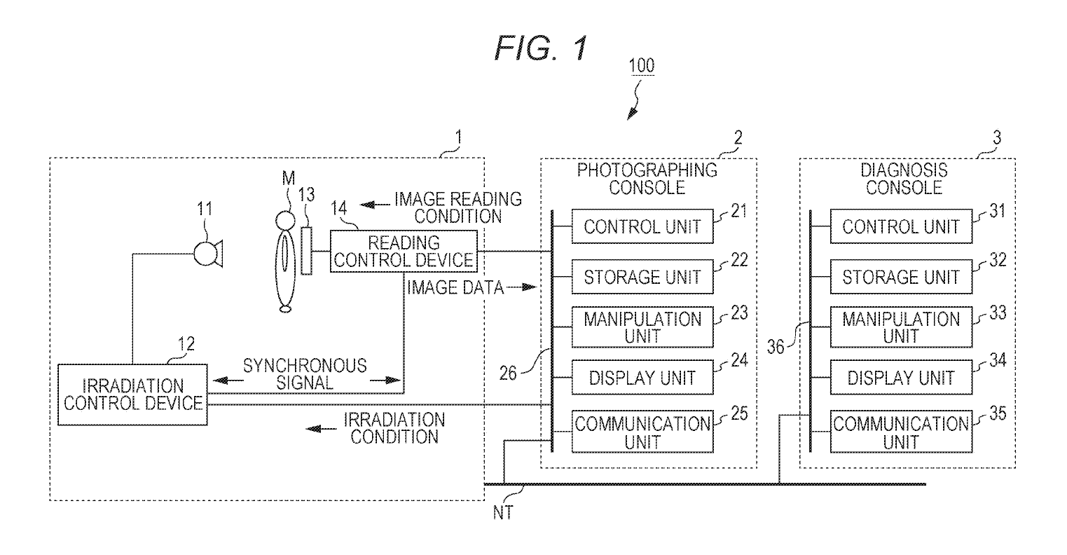

FIG. 1 illustrates the entire structure of a dynamic analysis system 100 in the present embodiment.

As illustrated in FIG. 1, in the dynamic analysis system 100, a photographing device 1 and a photographing console 2 are connected to each other through a communication cable or the like, and the photographing console 2 and a diagnosis console 3 are connected to each other through a communication network NT such as a LAN (Local Area Network). The devices included in the dynamic analysis system 100 comply with DICOM (Digital Image and Communications in Medicine) standard, and the communication between the devices is performed based on DICOM.

[Structure of Photographing Device 1]

The photographing device 1 is a photographing unit that photographs the dynamic state of a living body, for example, the form change of lungs in expansion and contraction along with the respiratory movement, the pulsation of a heart, and the like. Photographing the dynamic state refers to obtaining a plurality of images by repeatedly irradiating a subject with the radial rays such as X-rays in a pulsed manner at predetermined time intervals (pulsed irradiation) or continuously irradiating the subject with the radial rays such as X-rays at low dose rate (continuous irradiation). A series of images obtained by the photographing of the dynamic state is called the dynamic images. Each of the plurality of images constituting the dynamic images is called a frame image. In the embodiment below, description is made of an example in which the photographing of the dynamic state is performed by the pulsed irradiation. Although the embodiment below will describe a case in which a lung field is the target part to be diagnosed, the target part is not limited to the lung field.

A radiation source 11 is disposed to face a radiation detector 13 with a subject M interposed therebetween, and emits radiation rays (X-rays) to the subject M in accordance with the control of an irradiation control device 12.

The irradiation control device 12 is connected to the photographing console 2, and controls the radiation source 11 on the basis of an irradiation condition input from the photographing console 2 to perform the radiographing. The irradiation condition input from the photographing console 2 includes, for example, the pulse rate, the pulse width, the pulse interval, the number of photographing frames in one photographing time, the value of X-ray tube current, the value of X-ray tube voltage, the additional filter type, or the like. The pulse rate is the number of irradiation shots per second, and coincides with the frame rate to be described below. The pulse width is the irradiation length of time per shot. The pulse interval is the time after the start of one irradiation and before the start of the next irradiation, and coincides with the frame interval to be described below.

The radiation detector 13 includes a semiconductor image sensor such as an FPD. The FPD includes, for example, a glass substrate or the like and has a plurality of detection elements (pixels) arranged in matrix at predetermined positions on the substrate. The detection element detects the radiation rays, which are emitted from the radiation source 11 and transmit through at least the subject M, in accordance with the intensity thereof, converts the detected radiation rays into electric signals, and then accumulates the signals. Each pixel includes a switching unit such as a TFT (Thin Film Transistor). In regard to FPDs, there are the indirect conversion type that converts the X-rays into electric signals through a scintillator by a photoelectric conversion element, and the direct conversion type that directly converts the X-rays into electric signals; either type is applicable. In the present embodiment, the pixel value (concentration value) of the image data generated in the radiation detector 13 is higher as more radiation rays transmit.

The radiation detector 13 is provided to face the radiation source 11 with the subject M interposed therebetween.

A reading control device 14 is connected to the photographing console 2. On the basis of an image reading condition input from the photographing console 2, the reading control device 14 controls the switching unit of each pixel of the radiation detector 13 to switch the reading of the electric signals accumulated in each pixel. By reading the electric signals accumulated in the radiation detector 13, the reading control device 14 obtains the image data. The image data correspond to the frame image. The reading control device 14 outputs the obtained frame image to the photographing console 2. The image reading condition is, for example, the frame rate, the frame interval, the pixel size, the image size (matrix size), or the like. The frame rate is the number of frame images to obtain per second and coincides with the pulse rate. The frame interval is the time after the start of one operation of obtaining the frame image and before the start of the next operation of obtaining the frame image, and coincides with the pulse interval.

The irradiation control device 12 and the reading control device 14 are connected to each other, and exchange synchronous signals with each other so that the irradiation operation and the image reading operation are synchronized with each other.

[Structure of Photographing Console 2]

The photographing console 2 outputs the irradiation condition and the image reading condition to the photographing device 1 to control the radiographing of the photographing device 1 and the operation of reading the radiographic image, and moreover displays the dynamic images obtained by the photographing device 1 so that a photographer such as a radiographer can check the positioning or whether the image is useful in diagnosis.

The photographing console 2 includes, as illustrated in FIG. 1, a control unit 21, a storage unit 22, a manipulation unit 23, a display unit 24, and a communication unit 25, and these units are connected through a bus 26.

The control unit 21 includes a CPU (Central Processing Unit), a RAM (Random Access Memory), and the like. In response to the manipulation of the manipulation unit 23, the CPU of the control unit 21 reads out the system program or various processing programs stored in the storage unit 22, develops the programs in the RAM, executes the various processes including a photographing control process to be described below in accordance with the developed programs, and intensively controls the operation of the units in the photographing console 2, and the irradiation operation and the reading operation of the photographing device 1.

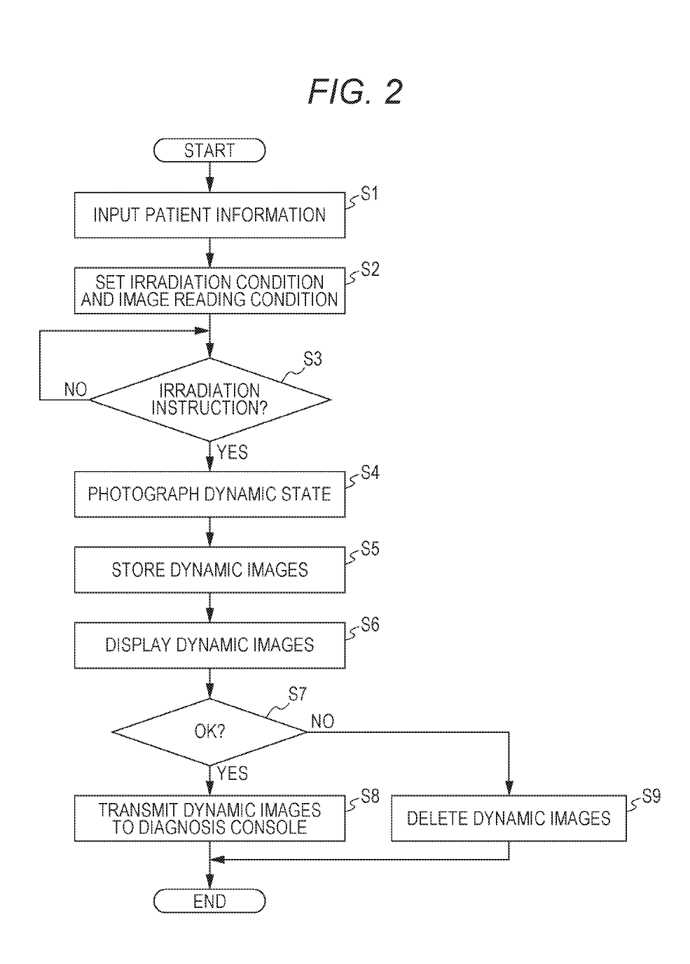

The storage unit 22 includes a nonvolatile semiconductor memory, a hard disk, or the like. The storage unit 22 stores the various programs to be executed in the control unit 21, the parameters necessary to execute the programs, or the data of the process results or the like. For example, the storage unit 22 stores the programs to execute the photographing control process illustrated in FIG. 2. In addition, the storage unit 22 stores the irradiation condition and the image reading condition in association with the photographed part. Various programs are stored in the readable program code format, and the control unit 21 sequentially executes the operation in accordance with the program code.

The manipulation unit 23 includes a keyboard having a cursor key, numeric keys, various function keys, or the like, and a pointing device such as a mouse, and outputs an instruction signal input by the key operation made through the keyboard or the mouse operation to the control unit 21. The manipulation unit 23 may include a touch panel on the display screen of the display unit 24, and in this case, the instruction signal input through the touch panel is output to the control unit 21.

The display unit 24 includes a monitor such as an LCD (Liquid Crystal Display), a CRT (Cathode Ray Tube), or the like, and displays the input instruction from the manipulation unit 23, the data, or the like in accordance with the instruction of the display signals input from the control unit 21.

The communication unit 25 includes a LAN adapter, a modem, a TA (Terminal Adapter), or the like and controls the data exchange between the devices connected to the communication network NT.

[Structure of Diagnosis Console 3]

The diagnosis console 3 is a dynamic analysis apparatus for supporting the doctor's diagnosis by: obtaining the dynamic images from the photographing console 2, analyzing the obtained dynamic images, generating analysis result images, and displaying the generated analysis result images.

The diagnosis console 3 includes, as illustrated in FIG. 1, a control unit 31, a storage unit 32, a manipulation unit 33, a display unit 34, and a communication unit 35, and these units are connected with a bus 36.

The control unit 31 includes a CPU, a RAM, and the like. In response to the manipulation of the manipulation unit 33, the CPU of the control unit 31 reads out the system program or various processing programs stored in the storage unit 32, develops the programs in the RAM, executes the various processes including an image analysis process to be described below in accordance with the developed programs, and intensively controls the operation of the units in the diagnosis console 3. The control unit 31 functions as a signal change extraction unit, a reference value setting unit, or a generating unit.

The storage unit 32 includes a nonvolatile semiconductor memory, a hard disk, or the like. The storage unit 32 stores various programs including the program to execute the image analysis process in the control unit 31, the parameters necessary to execute the programs, or the data of the process results or the like. These various programs are stored in the readable program code format, and the control unit 31 sequentially executes the operation in accordance with the program code.

The manipulation unit 33 includes a keyboard having a cursor key, numeric keys, various function keys, or the like, and a pointing device such as a mouse, and an instruction signal input by the key operation made through the keyboard or the mouse operation is output to the control unit 31. The manipulation unit 33 may include a touch panel on the display screen of the display unit 34, and in this case, the instruction signal input through the touch panel is output to the control unit 31.

The display unit 34 includes a monitor such as an LCD, a CRT, or the like, and performs various displays in accordance with the instruction of the display signals input from the control unit 31.

The communication unit 35 includes a LAN adapter, a modem, a TA, or the like and controls the data exchange between the devices connected to the communication network NT.

[Operation of Dynamic Analysis System 100]

Next, the operation of the dynamic analysis system 100 is described.

(Operation of Photographing Device 1 and Photographing Console 2)

First, the photographing operation by the photographing device 1 and the photographing console 2 is described.

FIG. 2 illustrates the photographing control process to be executed in the control unit 21 of the photographing console 2. The photographing control process is executed by the co-operation between the control unit 21 and the programs stored in the storage unit 22.

First, a photographer manipulates the manipulation unit 23 of the photographing console 2 to input pieces of patient information of a testee (subject M) (such as name, body height, body weight, age, and sex), and the checkup information (the photographed part (here, chest), the kind of analysis target (ventilation, blood flow, or the like)) (step S1).

Next, the irradiation condition is read out from the storage unit 22 and set in the irradiation control device 12. In addition, the image reading condition is read out from the storage unit 22 and set in the reading control device 14 (step S2).

Next, the instruction of irradiation by the manipulation of the manipulation unit 23 is awaited (step S3). Here, the photographer places the subject M between the radiation source 11 and the radiation detector 13 and adjusts the positions. In the present embodiment, the photographing is performed while the testee (subject M) breathes, the photographer tells the subject to relax and breathe normally. If necessary, the photographer can tell the subject to breathe deeply by instructing “breathe in and breathe out”. After the photographing preparation is completed, the photographer manipulates the manipulation unit 23 to input the radiation instruction.

Upon the input of the irradiation instruction by the manipulation unit 23 (YES in step S3), the photographing start instruction is output to the irradiation control device 12 and the reading control device 14 and thus the photographing of the dynamic state is started (step S4). That is to say, the radiation source 11 emits the radial rays at the pulse intervals set in the irradiation control device 12, and thus, the frame images are obtained by the radiation detector 13.

When the photographing of a predetermined number of frames is completed, the control unit 21 outputs the instruction of stopping the photographing to the irradiation control device 12 and the reading control device 14, and thus the photographing operation is stopped. The number of frames to be photographed is the number that can photograph at least one breathing cycle.

The frame images obtained by the photographing are sequentially input to the photographing console 2, and stored in the storage unit 22 in association with the number (frame number) expressing the photographing order (step S5), and are displayed in the display unit 24 (step S6). The photographer checks the positioning and the like by the displayed dynamic images, and determines whether the obtained image is suitable for the diagnosis (photographing: OK) or another photographing is necessary (photographing: FAIL). Then, the photographer manipulates the manipulation unit 23 to input the determination result.

When the determination result expressing the photographing: OK has been input by the predetermined manipulation of the manipulation unit 23 (YES in step S7), the pieces of information such as the identification ID for identifying the dynamic images, the patient information, the checkup information, the irradiation condition, the image reading condition, and the number expressing the photographing order (frame number) are added to each of a series of frame images obtained in the photographing of the dynamic state (for example, written in the header region of the image data in the DICOM format), and the dynamic images are transmitted to the diagnosis console 3 through the communication unit 25 (step S8). Thus, the present process ends. On the other hand, when the determination result expressing the photographing: FAIL has been input by the predetermined manipulation of the manipulation unit 23 (NO in step S7), a series of frame images stored in the storage unit 22 is deleted (step S9) and the present process ends. In this case, another photographing is required.

(Operation of Diagnosis Console 3)

Next, description is made of the operation of the diagnosis console 3.

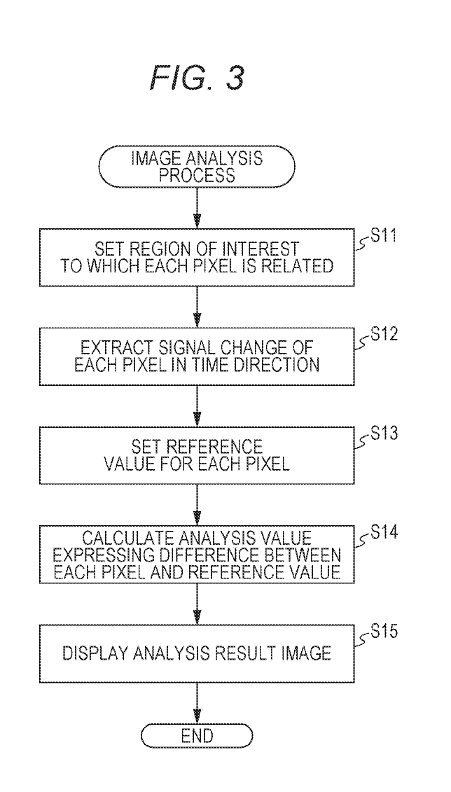

Upon the reception of a series of frame images of the dynamic images from the photographing console 2 through the communication unit 35, the diagnosis console 3 executes the image analysis process illustrated in FIG. 3 by the co-operation between the control unit 31 and the program stored in the storage unit 32.

Hereinafter, the image analysis process is described with reference to the flowchart of FIG. 3.

First, regions of interest are set (step S11), and each pixel of the dynamic images is related to the region of interest.

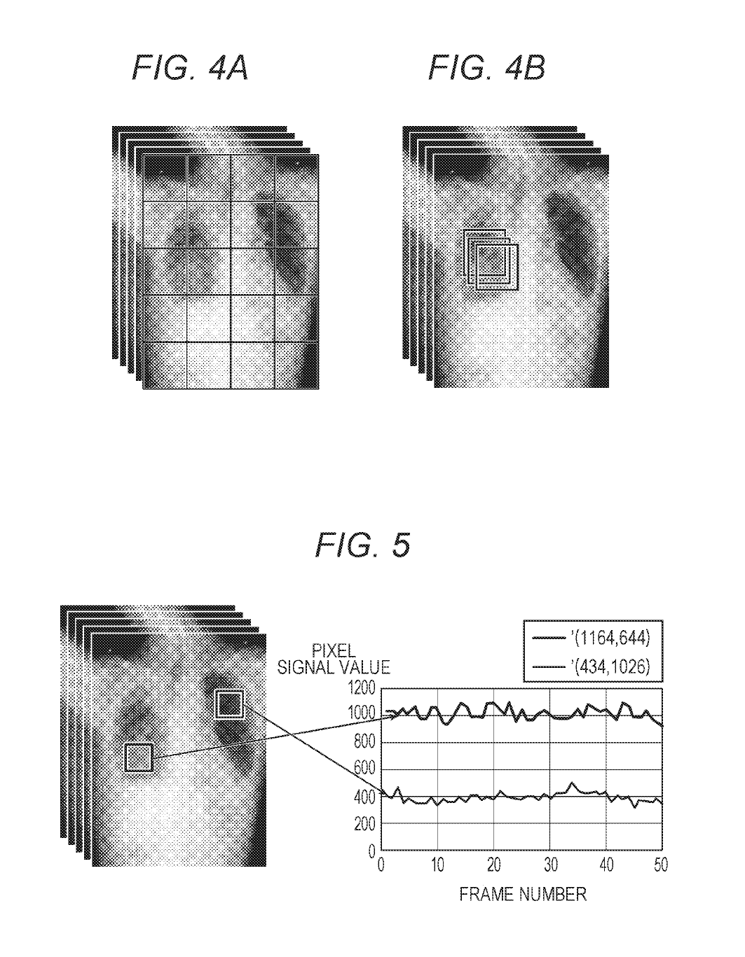

In the present embodiment, each pixel of the dynamic images is related to one region of interest, and such regions of interest are set all over the dynamic images. For example, the regions of interest may be set so as to divide the space of the entire image (without the overlapping between the regions of interest) as illustrated in FIG. 4A, or the regions of interest each of which is formed using a certain pixel as a center may overlap with each other as illustrated in FIG. 4B. In the case of FIG. 4A, each pixel in the region of interest belongs to that region of interest. In the case of FIG. 4B, the central pixel in the region of interest represents that region of interest. In the respective frame images, the regions of interest at the same coordinate position are the corresponding regions of interest.

Although FIGS. 4A and 4B illustrate the rectangular regions of interest, the shape is not limited to the rectangular one and may be elliptical or any other shape. The minimum size of the region of interest is 1 pixel×1 pixel.

In the present embodiment, the regions of interest are set to cover the entire dynamic images; however, the region of interest may be set to cover at least the region of the target part to be analyzed. For example, in the present embodiment, the target part is the lung field and therefore, the lung field region may be extracted by another unit and the region of interest may be set in only the lung field region.

The lung field may be extracted by any known method. For example, the threshold is obtained by analysis and determination from the histogram of the pixel values of the pixels in the frame image, and the region with signals higher than this threshold is obtained as the lung field region candidate; this is called primary extraction. Next, the edge detection is performed at and near the boundary of the lung field region candidate obtained by the primary extraction, and along the boundary, the points where the change is the maximum in the small region at and near the boundary are extracted; thus, the boundary of the lung field region can be extracted.

Before the region of interest is set, the lung region between the frame images may be aligned by warping the dynamic images.

Next, the signal change of each pixel in the time direction is extracted (step S12).

In step S12, the representative value of the pixel signal values in each region of interest set in each frame image (for example, the average value, the maximum value, the minimum value, the central value, or the like) is calculated and the signal change of the representative value of the pixel signal values in each region of interest in the time direction is extracted as the signal change of the pixel related to that region of interest in the time direction. The pixel signal value of each pixel is replaced by the representative value of the pixel signal values of the related region of interest. FIG. 5 shows one example of the signal change in the time direction extracted in step S12. Although FIG. 5 shows only the signal change of the pixels related to the two regions of interest in the time direction, in fact, the regions of interest exist in the entire image. It is not necessary to make the signal change extracted in step S12 into a graph, and the signal change maybe just held as the data internally (this similarly applies to the description below).

In this manner, by setting the representative value of the pixel signal values in the region of interest in each frame image to be the pixel signal value of the pixel related to that region of interest, the influence from the spatial noise can be reduced.

The process of relating each pixel with the region of interest and replacing the pixel signal value of each pixel with the representative value of the region of interest may be omitted.

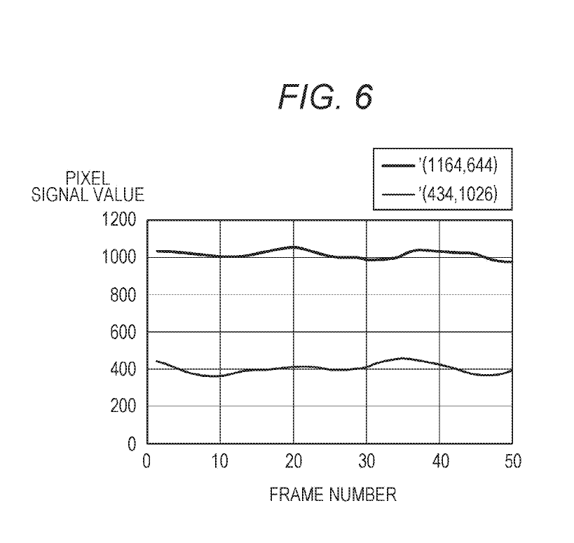

A frequency filter process in the time direction is preferably performed on the waveform of the signal change of the pixel signal value of each pixel in the time direction obtained in step S12. For example, if the kind of analysis target is the ventilation, a low-pass filter process with a predetermined cut-off frequency is performed; if the kind of analysis target is the blood flow, a band-pass filter process or a high-pass filter process with a predetermined cut-off frequency is preferably performed. This can extract the signal change in accordance with the kind of analysis target (for example, in the case of the ventilation, the signal change of the ventilation signal component; in the case of the blood flow, the signal change of the blood flow signal component). FIG. 6 illustrates an example in which the kind of analysis target is the ventilation and the low-pass filter process is performed on the signal change of each pixel in the time direction illustrated in FIG. 5.

Next, the reference value for each pixel is set (step S13).

For example, the maximum value, the minimum value, the average value, the central value, or the like in the signal change of each pixel in the time direction extracted in step S12 is set as the reference value. The reference value may be either the same or different for each pixel. Alternatively, the pixel signal value of each pixel in a particular frame image may be used as the reference value of each pixel. The particular frame image may be specified by a user through the manipulation unit 33. Further alternatively, a frame image with a particular phase (for example, the rest exhaling position and the rest inhaling position) may be used as the particular frame image, and in this case, the particular frame image may be determined by the automatic recognizing process. In one example of a method of the automatic recognizing process, the positon of the diaphragm (vertical position) is recognized from each frame image, and the frame image where the position of the diaphragm is the highest or the lowest can be recognized as the particular frame image. The position of the diaphragm can be recognized by a known image process such as the process according to JP 5521392 B2. In another example, the area of the lung field region is obtained by counting the pixel number of the lung field region from each frame image, and the frame image with the maximum area or the minimum area may be recognized as the particular frame image. In the automatic recognizing process, the dynamic images that are not warped are used.

Next, in regard to each pixel of each frame image, the analysis value representing the difference from the reference value is calculated (step S14). As the analysis value representing the difference from the reference value, for example, the difference from the reference value or the ratio is calculated.

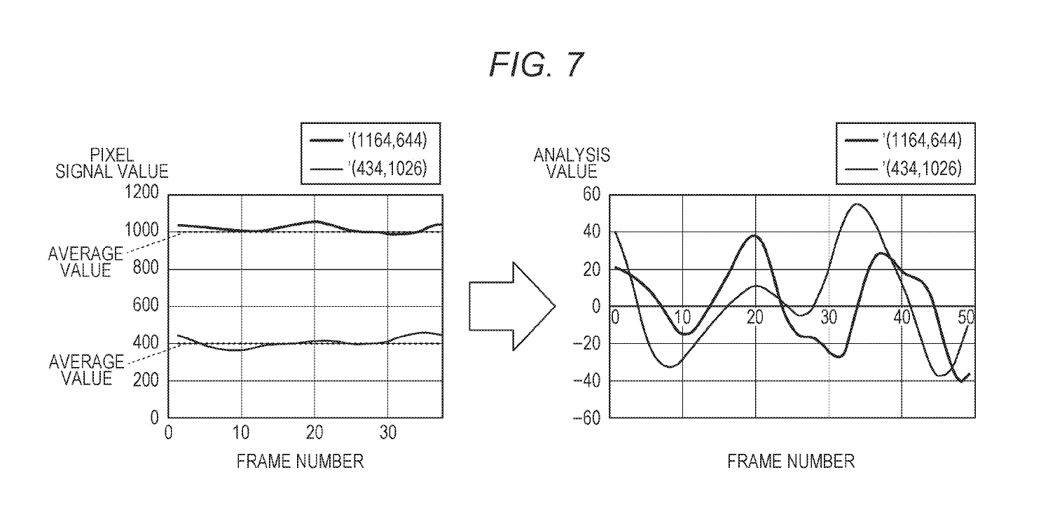

The average value of the signal change of the pixel signal value in the time direction shown in FIG. 6 is used as the reference value, and FIG. 7 shows the result of obtaining the difference between the reference value and the pixel signal value of each frame image. In the signal waveform shown in FIG. 7 in which the reference value is 0, the characteristic of the time change of the pixel signal value is remarkably observed.

Next, the analysis result images in which the pixels in the dynamic images are expressed in colors (concentrations) corresponding to the analysis values calculated instep S14 are generated and displayed in the display unit 34 (step S15).

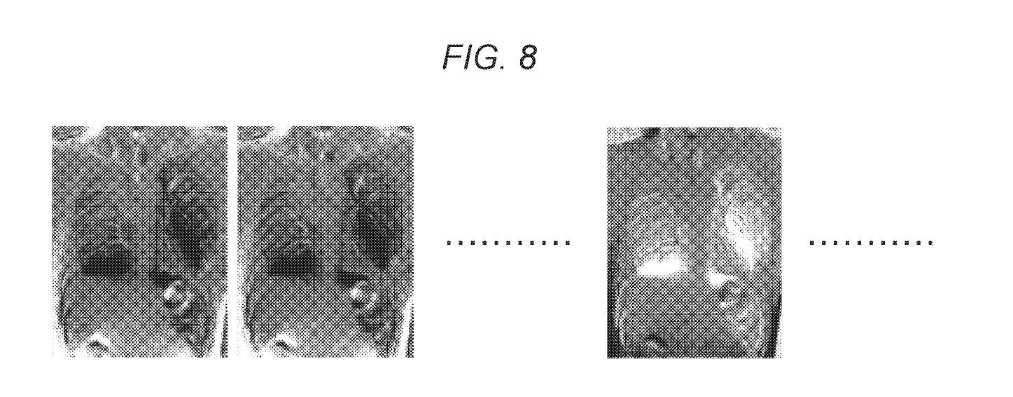

FIG. 8 shows an example of the analysis result images. In the example shown in FIG. 8, the analysis values in step S14 are colored with gray so that the values ranging from the minimum value to the maximum value of the analysis values have the colors ranging from black to white, respectively. The analysis result images may be displayed in a manner that the motion image is reproduced by sequentially switching the frame images like a movie or the frame images are displayed side by side as illustrated in FIG. 8. The part where the color changes from black to white in FIG. 8 corresponds to the part where the pixel signal value changes largely, and the part where the color remains gray corresponds to the part where the pixel signal value does not change. By displaying the frame images of the analysis result images as the motion image or side by side, the characteristic of the time change of the pixel signal value can be remarkably visualized with the correspondence of the frame images between the dynamic images and the analysis result images, and thus, the user such as a doctor can easily know the characteristic of the change in pixel signal value of the dynamic images in the time direction.

In step S15, it is preferable that the dynamic images as the source of analysis are displayed together with the analysis result images.

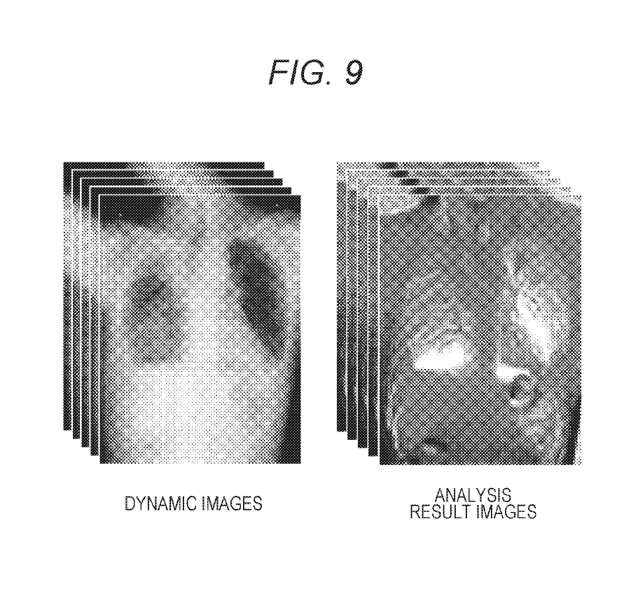

For example, as shown in FIG. 9, a motion image of the dynamic images and a motion image of the analysis result images may be displayed side by side. In this case, it is preferable that the corresponding frame images of the dynamic images and the analysis result images are displayed at the same time (in synchronization).

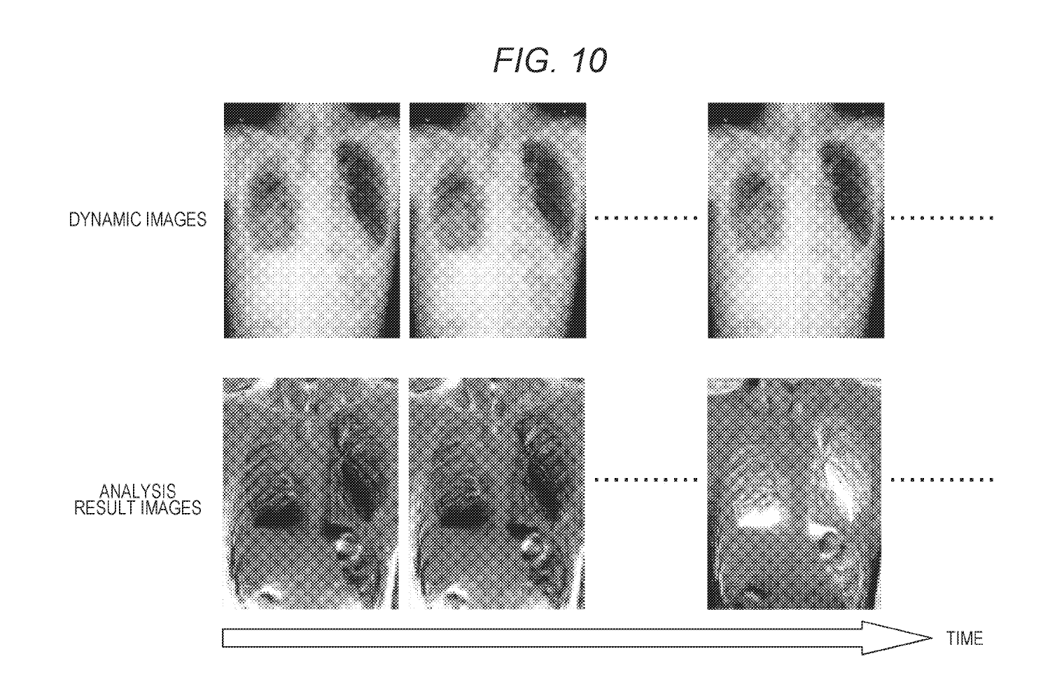

Alternatively, for example, the frame images of the dynamic images and the analysis result images may be displayed side by side as shown in FIG. 10. In this case, it is preferable that the images are displayed so that the correspondence between the dynamic images and the analysis result images is known. In FIG. 10, the upper and lower images are the corresponding frame images.

By displaying the frame images so that the correspondence between the dynamic images and the analysis result images is known as shown in FIGS. 9 and 10, the user such as a doctor can easily see the characteristic of the change of the pixel signal value of the dynamic images in the time direction while observing the dynamic images with the correspondence of the frame images between the dynamic images and the analysis result images.

The frame image of the analysis result images may be displayed overlaying on the corresponding frame image of the dynamic images. In this case, it is preferable to prepare the user interface to enable the user to change the transparency in the overlay.

In regard to the color of the analysis result images, not just the gray display but also the color display can be employed. For example, the display may have the color (for example, red, blue, and green) with the different luminance value in accordance with the analysis value in step S14. In another example, the part with an analysis value of 0 in step S14 may be colored black, the part with the positive analysis value maybe colored more reddish, and the part with the negative analysis value may be colored more greenish. In this case, it is preferable that the color difference between the colors assigned to the maximum value and the minimum value of the analysis values is the largest; for example, the hue is different the most largely or the luminance value is different the most largely. This enables the user to understand the magnitude of the analysis value at a glance.

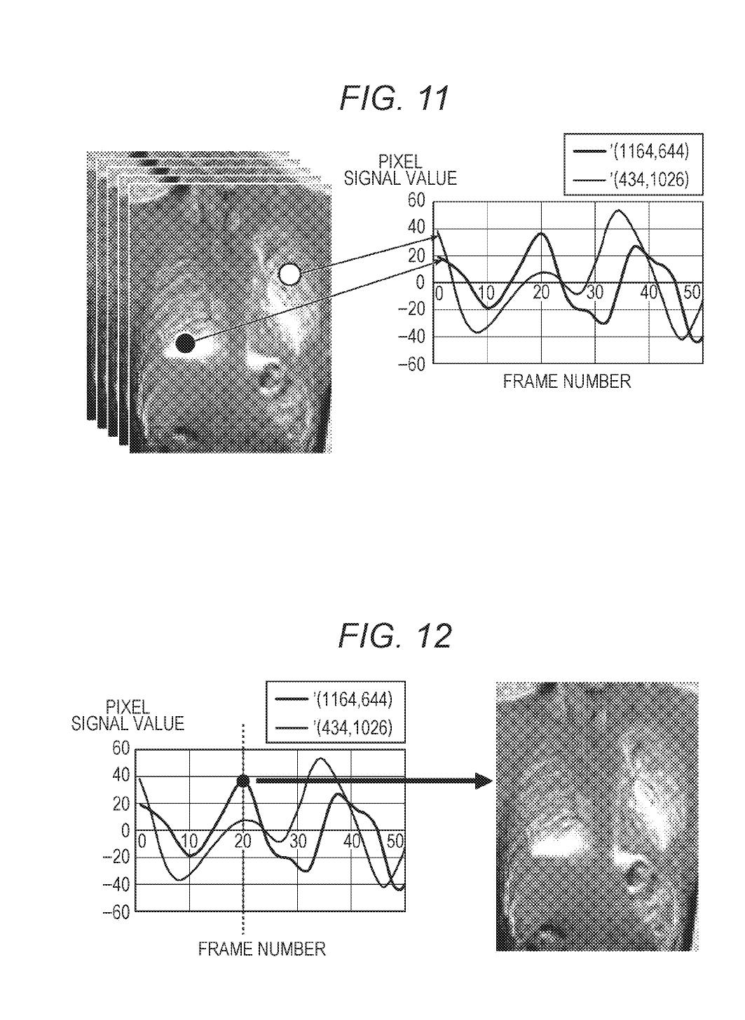

In step S15, the graph of the analysis values may be displayed together with the analysis result image. “The graph of the analysis values” is the graph of numeric data of the analysis values in the time direction at the point (pixel) on the analysis result image. For example, as illustrated in FIG. 11, the graph at the point specified by the user through the manipulation unit 33 on the analysis result image displayed in the display unit 34 may be displayed or the graph at a predetermined point may be displayed. Thus, the change of the analysis values at the specified position in the time direction can be displayed clearly.

In addition, as illustrated in FIG. 12, the graph of the analysis values may be displayed in the display unit 34 and the frame image of the analysis result images corresponding to the point specified by the user through the manipulation unit 33 on the displayed graph may be displayed in the display unit 34. Thus, for example, if there is a point on the graph of the analysis value which the user is concerned about, the user can immediately display and observe the analysis result image at that timing.

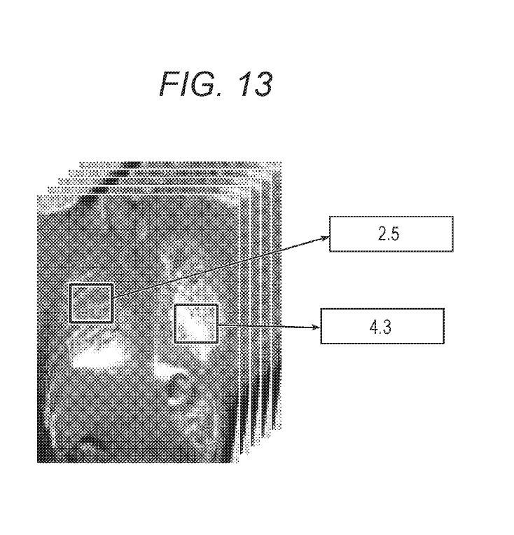

Moreover, as shown in FIG. 13, a predetermined region may be set relative to the analysis result image and the representative value of the analysis result values in that predetermined region may be used as the quantitative value and displayed in the display unit 34. The quantitative value may be the maximum value, the minimum value, the average value, or the central value of the pixel signal values in the predetermined region. When the quantitative value is calculated, another reference may be provided and the ratio based on this reference may be calculated (for example, in percentage). By displaying the quantitative value of the analysis result of the predetermined region in this manner, the state of the pixel signal value in that predetermined region can be shown in numeral.

The predetermined region may be, for example, a region specified by the user through the manipulation of the manipulation unit 33. The predetermined region may be one point (one pixel). The predetermined region may alternatively be a region in accordance with an anatomical structure of the target part (for example, if the target part is the lung field, the region may be the region corresponding to the superior lobe of the right lung field). A plurality of predetermined regions maybe set. When the plurality of predetermined regions is set, the quantitative values of the plurality of predetermined regions can be compared and the part with abnormality can be found more easily.

As described above, with the diagnosis console 3, the control unit 31 sets a plurality of regions of interest to each of which each pixel is related, with respect to each frame image of the dynamic images of the chest part and calculates the representative value of the pixel signal values within the set region of interest as the pixel signal value of the pixel related to the region of interest, and thus extracts the signal change of the pixel signal value of each pixel in the time direction. Next, the control unit 31 sets the reference value for each pixel on the basis of the time change of each pixel, and calculates the analysis value representing the difference between the reference value set for each pixel and the pixel signal value of each pixel in each frame image of the dynamic images, thereby generating the analysis result images including the plurality of frame images. Then, the plurality of frame images of the generated analysis result images is displayed as a motion image or side by side in the display unit 34.

Therefore, the characteristic of the time change of the pixel signal value can be remarkably visualized with the correspondence of the frame images between the dynamic images and the analysis result images, so that the user such as a doctor can easily know the characteristic of the change of the pixel signal value of the dynamic images in the time direction.

In another example, the frequency filter process is performed on the signal change of the pixel signal value of each extracted pixel in the time direction, so that the user such as a doctor can easily know the characteristic of the change of the signal component of the dynamic images in the time direction in accordance with the kind of analysis target.

In still another example, the analysis result images having the color according to the analysis value for each pixel are displayed in the display unit 34. This can clearly visualize the characteristic of the time change of the pixel signal values. The colors for the analysis values are assigned so that the color difference between the maximum value and the minimum value of the analysis values is the largest. Thus, the user can easily understand the magnitude of the analysis values at a glance.

When a motion image of the dynamic images and a motion image of the analysis result images are displayed side by side, the corresponding frame images of the dynamic images and the analysis result images are displayed side by side, or the frame image of the analysis result images is displayed overlaying on the corresponding frame image of the dynamic images, the user such as a doctor can easily understand the characteristic of the change in pixel signal value of the dynamic images in the time direction with the correspondence of the frame images between the dynamic images and the analysis result images.

By displaying the graph expressing the change of the analysis value at a predetermined point set on the analysis result image in the time direction together with the analysis result image, the change of the analysis value at the predetermined position in the time direction can be displayed clearly.

Together with the analysis result image, the representative value of the analysis values in the predetermined region set on the analysis result image is displayed. Thus, the state of the pixel signal value in that predetermined region can be displayed in numerals.

Note that the present embodiment is about one example of the preferable dynamic analysis system according to the present invention, and is not limited to the system described herein.

For example, the target part is the lung field in the above embodiment but the target part is not limited to the lung field, and the dynamic images may be obtained by photographing another part.

Although the computer readable medium for the program according to the present invention is the hard disk, the semiconductor nonvolatile memory, or the like in the above description, the present invention is not limited thereto. Another computer readable medium such as a portable recording medium such as a CD-ROM is also applicable. A carrier wave is also applicable as the medium that provides the data of the program according to the present invention through the communication line.

In regard to other detailed structure and operation of the devices included in the dynamic analysis system 100, various changes can be made without departing from the concept of the present invention.

Although the present invention has been described and illustrated in detail, it is clearly understood that the same is by way of illustrated and example only and is not to be taken byway of limitation, the scope of the present invention being interpreted by terms of the appended claims.

What is claimed is:

1. A dynamic analysis apparatus comprising:
a signal change extracting unit configured to extract from dynamic images obtained by radiographing a subject including a target part in a living body, a signal change of a pixel signal value of each pixel in at least a region of the target part in a time direction;
a reference value setting unit configured to set a reference value for each pixel on the basis of the signal change of each pixel;
a generating unit configured to calculate an analysis value expressing a difference between the pixel signal value of each pixel in each frame image of the dynamic images and a reference value set for a time change of each pixel, thereby generating analysis result images including a plurality of frame images; and
a displaying unit configured to display the plurality of frame images of the analysis result images as a motion image or side by side.

2. The dynamic analysis apparatus according to claim 1, wherein
the signal change extracting unit sets a plurality of regions of interest to each of which each pixel in at least the region of the target part is related for each frame image of the dynamic images, calculates a representative value of pixel signal values in the set region of interest as the pixel signal value of the pixel related to the region of interest, and extracts the signal change of the pixel signal value of each pixel in the time direction.

3. The dynamic analysis apparatus according to claim 2, wherein
the representative value of the pixel signal values in the region of interest is an average value, a central value, a maximum value, or a minimum value of the pixel signal values in the region of interest.

4. The dynamic analysis apparatus according to claim 1, wherein
the signal change extracting unit performs a frequency filter process on the extracted signal change of the pixel signal value of each pixel in the time direction.

5. The dynamic analysis apparatus according to claim 1, wherein
the reference value setting unit sets the reference value of each pixel to an average value, a central value, a maximum value, or a minimum value of the signal change of the pixel signal value of each pixel in the time direction.

6. The dynamic analysis apparatus according to claim 1, wherein
the reference value setting unit sets the pixel signal value of each pixel in a particular frame image of the dynamic images as the reference value of each pixel.

7. The dynamic analysis apparatus according to claim 1, wherein
the generating unit calculates a difference between the pixel signal value of each pixel and the reference value set to each pixel or a ratio thereof as an analysis value expressing a difference between the pixel signal value of each pixel in each frame image of the dynamic images and the reference value set to each pixel.

8. The dynamic analysis apparatus according to claim 1, wherein
the displaying unit displays the analysis result images having a color according to the analysis value in each pixel.

9. The dynamic analysis apparatus according to claim 8, wherein
the color according to the analysis value is assigned so that a color difference between colors corresponding to a maximum value and a minimum value of the analysis value is the largest.

10. The dynamic analysis apparatus according to claim 1, wherein
the displaying unit displays a motion image of the dynamic images and a motion image of the analysis result images side by side.

11. The dynamic analysis apparatus according to claim 1, wherein
the displaying unit displays the frame images of the dynamic images and the corresponding frame images of the analysis result images side by side.

12. The dynamic analysis apparatus according to claim 1, wherein
the displaying unit displays the dynamic images and the analysis result images while overlaying each frame image of the analysis result images on the corresponding frame image of the dynamic images.

13. The dynamic analysis apparatus according to claim 1, wherein
the displaying unit displays a graph expressing a change of the analysis value at a predetermined point set on the analysis result image in a time direction together with the analysis result image.

14. The dynamic analysis apparatus according to claim 1, wherein
the displaying unit displays a representative value of analysis values in a predetermined region set on the analysis result image together with the analysis result image.
